(19) United States
(12) Patent Application Publication
(10) Pub. No.: US 2021/0118002 A1
(43) Pub. Date: Apr. 22, 2021

(54) E-COMMERCE CUSTOM-TAILORED PRICING

(71) Applicant: WeWorld LLC, Los Angeles, CA (US)

(72) Inventor: Hojun Kim, Los Angeles, CA (US)

(21) Appl. No.: 16/833,079

(22) Filed: Mar. 27, 2020

Related U.S. Application Data
(60) Provisional application No. 62/924,080, filed on Oct. 21, 2019.
(60) Provisional application No. 62/936,246, filed on Nov. 15, 2019.

(51) Int. Cl. G06Q 30/02; G06Q 20/32

(52) U.S. Cl. CPC G06Q 30/0222; G06Q 30/0236; G06Q 30/0239; G06Q 20/3276

(57) ABSTRACT

Receiving a consumer-tailored pricing at a mobile device, including: selecting a product having a product identifier from an online seller using the mobile device; reading a consumer ID from a consumer card using the mobile device; transmitting first data including the product identifier of the selected product, the consumer ID, and desired price and quantity of the selected product to a consumer service provider, wherein the consumer service provider generates a purchase code based on the first data once the consumer ID is verified, wherein the consumer ID is verified when the consumer service provider sends a verification code to the mobile device and receives back the verification code to verify that the consumer ID is associated with the mobile device which is registered with the consumer service provider along with the consumer ID.

### CROSS-REFERENCE TO RELATED APPLICATIONS

This application claims the benefit of priority under 35 U.S.C. § 119(e) of: co-pending U.S. Provisional Patent Application No. 62/924,080, filed Oct. 21, 2019, entitled “E-commerce System Enabling Autonomous Pricing by Consumer”; and co-pending U.S. Provisional Patent Application No. 62/936,246, filed Nov. 15, 2019, entitled “E-commerce System with Novel Pricing and Selling Policy”. The disclosures of the above-referenced applications are incorporated herein by reference.

### BACKGROUND

### Field

The present disclosure relates to an e-commerce pricing, and more specifically, to an e-commerce pricing custom-tailored to a consumer.

### Background

With increased online shopping, price competition among online sellers is increasing with proliferation of price comparison sites that offer lowest prices for products selected by online shoppers. Thus, the price comparison sites help consumers to compare prices of products from different sellers and enable the consumers to make informed decisions regarding the online purchase of products.

### SUMMARY

The present disclosure provides for an e-commerce pricing custom-tailored to a consumer.

In one implementation, a method for receiving a consumer-tailored pricing at a mobile device is disclosed. The method includes: selecting a product having a product identifier from an online seller using the mobile device; reading a consumer ID from a consumer card using the mobile device; transmitting first data including the product identifier of the selected product, the consumer ID, and desired price and quantity of the selected product to a consumer service provider, wherein the consumer service provider generates a purchase code based on the first data once the consumer ID is verified, wherein the consumer ID is verified when the consumer service provider sends a verification code to the mobile device and receives back the verification code to verify that the consumer ID is associated with the mobile device which is registered with the consumer service provider along with the consumer ID; receiving the purchase code from the consumer service provider and transmitting the purchase code to the online seller; and receiving the consumer-tailored pricing for the selected product from the online seller.

In one implementation, the custom-tailored pricing for the selected product is generated by the online seller and transmitted to the mobile device once purchase codes received from the consumer service provider and the mobile device match. In one implementation, the consumer service provider generates the purchase code when requests are received from both the online seller and the mobile device. In one implementation, the consumer ID is in a code form. In one implementation, the consumer service provider generates the purchase code using a purchase history of the consumer in addition to the first data received from the mobile device. In one implementation, the method further includes determining whether the consumer had purchased the selected product before from the online seller; and retrieving and using a detailed purchase history of the selected product in addition to purchase history of the consumer when it is determined that the consumer had purchased the selected product before from the online seller. In one implementation, the method further includes retrieving and using consumer ratings and online shopping habits of the consumer in addition to purchase history of the consumer. In one implementation, the consumer service provider generates the purchase code on a point system.

In another implementation, a system for receiving a consumer-tailored pricing by generating a purchase code after authenticating an association between a mobile device and a consumer card is disclosed. The system includes: a consumer service provider; a memory; a downloadable software module that operates on the mobile device, the software module including instructions to browse, select, and transmit a product identifier of a product selected from an online seller, desired price and quantity of the selected product, and a consumer ID to the consumer service provider, and a processor coupled to the memory programmed with executable instructions, including, a consumer interface including a reader for obtaining the consumer ID from the consumer card, wherein the consumer interface transmits the consumer ID to the mobile device; wherein the consumer service provider generates and transmits a purchase code based on the first data once the consumer ID is verified, wherein the consumer ID is verified when the consumer service provider sends a verification code to the mobile device and receives back the verification code to verify that the consumer ID is associated with the mobile device which is registered with the consumer service provider along with the consumer ID; and wherein the processor receives the purchase code from the consumer service provider and transmits the purchase code to the online seller, and receives the consumer-tailored pricing for the selected product from the online seller.

In one implementation, the consumer card is issued by the consumer service provider. In one implementation, the consumer card is issued by a third party credit company not related to the consumer service provider. In one implementation, the reader is a code reader coupled to the mobile device. In one implementation, the consumer ID is one of bar code or QR code printed on the consumer card. In one implementation, the consumer ID is a code embedded in the consumer card which is read by the reader coupled to the mobile device. In one implementation, the consumer service provider is a credit service provider which evaluates the online credit ratings of consumers and provides online sellers with standards with which to determine the prices for products offered online by the online sellers.

In another implementation, a non-transitory computer reachable storage medium storing a computer program to receive a consumer-tailored pricing is disclosed. The computer program includes executable instructions that cause a computer to: select a product having a product identifier from an online seller; read a consumer ID from a consumer card; transmit first data including the product identifier of the selected product, the consumer ID, and desired price and quantity of the selected product to a consumer service provider, wherein the consumer service provider generates a purchase code based on the first data once the consumer ID is verified, wherein the consumer ID is verified when the consumer service provider sends a verification code to the computer and receives back the verification code to verify that the consumer ID is associated with the computer which is registered with the consumer service provider along with the consumer ID; receive the purchase code from the consumer service provider and transmit the purchase code to the online seller; and receive the consumer-tailored pricing for the selected product from the online seller.

In one implementation, the custom-tailored pricing for the selected product is generated by the online seller and transmitted to the computer once purchase codes received from the consumer service provider and the computer match. In one implementation, the consumer service provider generates the purchase code when requests are received from both the online seller and the computer. In one implementation, the consumer service provider generates the purchase code on a point system. In one implementation, the consumer ID is in a code form.

Other features and advantages should be apparent from the present description which illustrates, by way of example, aspects of the disclosure.

### BRIEF DESCRIPTION OF THE DRAWINGS

The details of the present disclosure, both as to its structure and operation, may be gleaned in part by study of the appended drawings, in which like reference numerals refer to like parts, and in which:

FIG. 1 is a block diagram of an e-commerce system for consumer-tailored pricing in accordance with one implementation of the present disclosure;

FIG. 2 is a flow diagram of an e-commerce method for receiving consumer-tailored pricing at a mobile device according to one implementation of the present disclosure;

FIG. 3 is a flow diagram of an e-commerce method from the consumer service provider side in accordance with one implementation of the present disclosure;

FIG. 4 is a flow diagram of an e-commerce method from the online seller side in accordance with one implementation of the present disclosure;

FIG. 5A is a representation of a computer system and a user in accordance with an implementation of the present disclosure; and

FIG. 5B is a functional block diagram illustrating the computer system hosting an e-commerce application in accordance with an implementation of the present disclosure.

### DETAILED DESCRIPTION

As noted above, price competition among online sellers are increasing with proliferation of price comparison sites that offer lowest prices for products selected by online shoppers.

Certain implementations of the present disclosure include enabling the consumer to select and purchase a product by offering multiple prices for different quantities of the product. In one implementation, the multiple prices offered to the consumer are based on the purchase history and the rating of the consumer. In another implementation, a purchase code is generated based on the purchase history and the rating of the consumer so that the online seller may base the offered prices on the purchase code. In a further implementation, a consumer card and a mobile device are used to identify the consumer and to enable a consumer service provider and the online seller to determine appropriate prices for the products selected by the consumer.

After reading the descriptions recited in this section, it will become apparent how to implement the disclosure in various implementations and applications. Although various implementations of the present disclosure will be described herein, it is understood that these implementations are presented by way of example only, and not limitation. As such, the detailed description of various implementations should not be construed to limit the scope or breadth of the present disclosure.

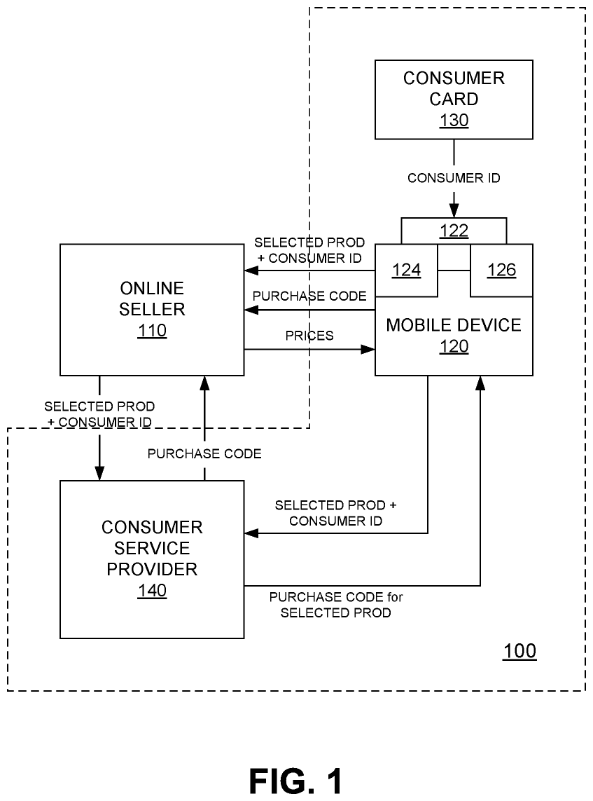

FIG. 1 is a block diagram of an e-commerce system 100 for consumer-tailored pricing in accordance with one implementation of the present disclosure. In the illustrated implementation of FIG. 1, the system 100 includes interconnection of a mobile device 120 belonging to the consumer, a consumer card 130, and a consumer service provider 140. The system 100 uses the mobile device 120 to read an identifier of the consumer (“consumer ID”) from a consumer card 130. The system 100 interacts with an online seller 110. In one implementation, the consumer card 120 is issued by the consumer service provider 140. In another implementation, the consumer card 120 is issued by a third party credit company not related to the consumer service provider 140.

In one implementation, the consumer ID is read using the camera on the mobile device 120. In another implementation, the consumer ID is read by a code reader coupled to the mobile device 120. In one implementation, the consumer ID is a number printed on the consumer card 130. In another implementation, the consumer ID is a bar code or QR code printed on the consumer card 130. In yet another implementation, the consumer ID is a code embedded in the consumer card 130 which must be read by the mobile device 120 and transmitted to the consumer service provider 140 to verify the consumer ID. In one implementation, the consumer card 130 is a credit card issued by the consumer service provider.

In one implementation, the mobile device 120 is a mobile phone including a built-in camera and an interface port for connecting other communication devices such as a code reader 122. In another implementation, the mobile device 120 is a laptop computer including a built-in camera and an interface port for connecting other communication devices such as a code reader 122. In yet another implementation, the mobile device 120 is a desktop computer having an interface port for connecting other communication devices such as a code reader 122. Thus, in the case of the desktop computer, the device 120 is usually stationary.

In one implementation, the online seller 110 is an online merchant with fixed website address(es) having multiple pages of merchandises for sale on the Internet. Prices for the merchandises are set after the consumer selects product(s) and submits the consumer ID. In another implementation, the online seller 110 is a private online distributor showing merchandises for sale at the request of the consumer.

In one implementation, the consumer service provider 140 is a service provider which evaluates the online shopping habits and ratings of consumers and provides the merchants with standards with which to determine the prices for the products offered online by the merchants. In another implementation, the consumer service provider 140 is a credit service provider which evaluates the online credit ratings of consumers and provides the merchants with standards with which to determine the prices for the merchandises offered online by the merchants. In this implementation, the consumer service provider 140 also provides credit to the consumer identified by the consumer card 130.

In another implementation, the e-commerce system 100 for receiving a consumer-tailored pricing by generating a purchase code after authenticating an association between a mobile device and a consumer card is disclosed. The system 100 includes: a consumer service provider 140; a memory 124; a downloadable software module that operates on the mobile device, the software module including instructions to browse, select, and transmit a product identifier of a product selected from an online seller, desired price and quantity of the selected product, and a consumer ID to the consumer service provider 140, and a processor 126 coupled to the memory 124 programmed with executable instructions, including, a consumer interface including a reader 122 for obtaining the consumer ID from the consumer card 130, wherein the consumer interface transmits the consumer ID to the mobile device 120; wherein the consumer service provider 140 generates and transmits a purchase code based on the first data once the consumer ID is verified, wherein the consumer ID is verified when the consumer service provider 140 sends a verification code to the mobile device 120 and receives back the verification code to verify that the consumer ID is associated with the mobile device 120 which is registered with the consumer service provider 140 along with the consumer ID; and wherein the processor 126 receives the purchase code from the consumer service provider 140 and transmits the purchase code to the online seller 110, and receives the consumer-tailored pricing for the selected product from the online seller 110.

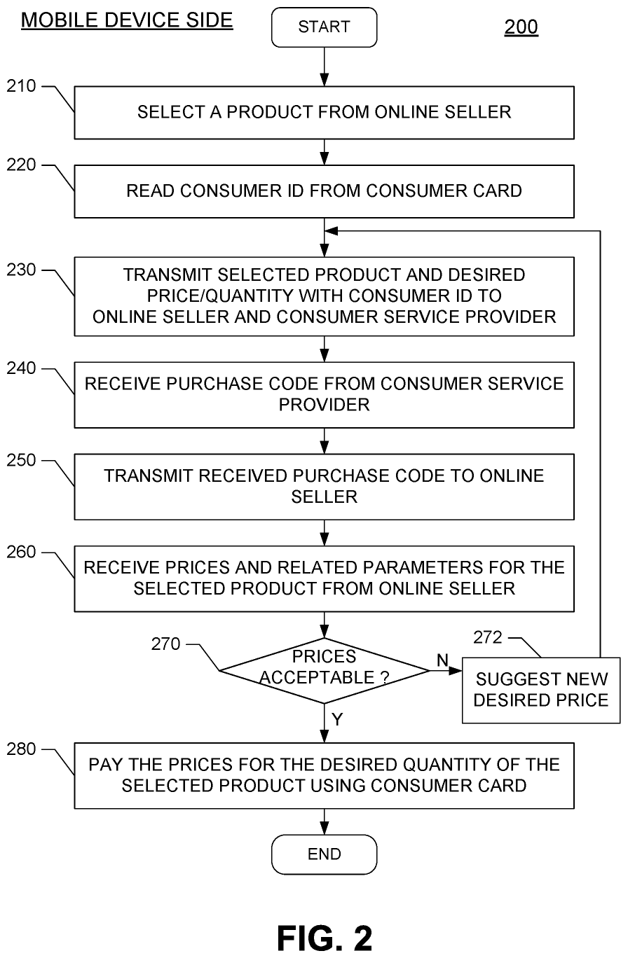

FIG. 2 is a flow diagram of an e-commerce method 200 for receiving consumer-tailored pricing at the mobile device 120 in accordance with one implementation of the present disclosure. In the illustrated implementation of FIG. 2, a consumer uses the mobile device 120, at step 210, to browse and select a product from the online seller 110. Once the consumer selects the product, the mobile device 120 is used, at step 220, to read the consumer ID from the consumer card 130. The mobile device 120 is then used, at step 230, to transmit the identifier of the selected product, the desired price and quantity, and the consumer ID to the online seller 110 and the consumer service provider 140.

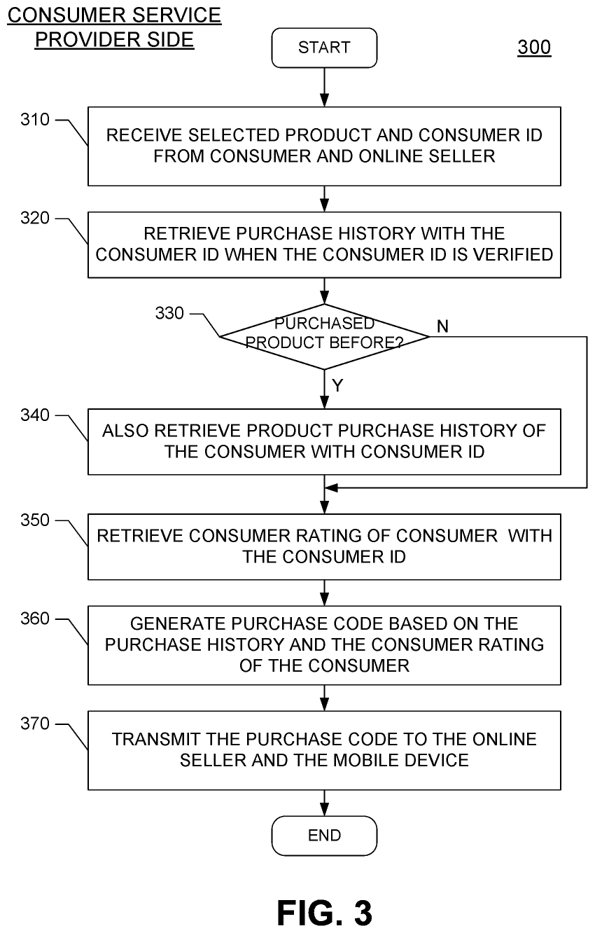

FIG. 3 is a flow diagram of an e-commerce method 300 from the consumer service provider side in accordance with one implementation of the present disclosure. In the illustrated implementation of FIG. 3, the identifier of the selected product, the desired price and quantity, and the consumer ID are received, at step 310, from the mobile device 120 and the online seller 110. In one implementation, the consumer service provider 140 performs the analysis to generate a purchase code only if the same request is receive from both the online seller 110 and the mobile device 120.

A purchase history of the consumer is retrieved, at step 320, with the receive consumer ID. In one implementation, the consumer ID is in a code form so that it cannot be readily misused for purposes other than for online shopping. In step 320, the consumer service provider 140 also performs a verification of the consumer ID to confirm that the consumer ID is valid and is associated with the mobile device 120 from which the consumer ID was received. Thus, in one implementation, a verification code may be sent to the mobile device 120 to confirm the consumer ID.

At step 330, an inquiry is made to determine whether the consumer had purchased the selected product before from the online seller 110. If it is determined, at step 330, that the consumer had purchased the selected product before, a more detailed product purchase history is retrieved, at step 340. Otherwise, step 340 is skipped. The consumer service provider 140 also retrieves, at step 350, the consumer ratings and online shopping habits of the consumer with the consumer ID. The consumer service provider 140 then generates, at step 360, a purchase code based on the retrieved purchase history, the consumer rating, and the online shopping habits of the consumer. The generated purchase code is then transmitted, at step 370, to the online seller 110 and the mobile device 120.

In one implementation, the purchase code is generated on a point system in which the retrieved purchase history, the consumer rating, and the online shopping habits of the consumer each get a number between 0 and 10 and the total score (between 0 and 30) is divided by the total number of parameters (3 in this case). If the consumer had purchased the selected product before from the online seller, the retrieved product purchase history is added as a fourth parameter and is also scored such that the total score is divided by 4. In another implementation, the purchase code is generated by plotting each parameter as a graph and taking the slope of each curve to produce a single number that is a sum of the slopes of all parameters. In yet another implementation, the purchase code is generated as multiple digits, wherein each digit represents the slope of each curve.

Referring back to FIG. 2, in one implementation, the mobile device 120 receives the purchase code, at step 240, from the consumer service provider 140, and transmits the received purchase code to the online seller 110, at step 250.

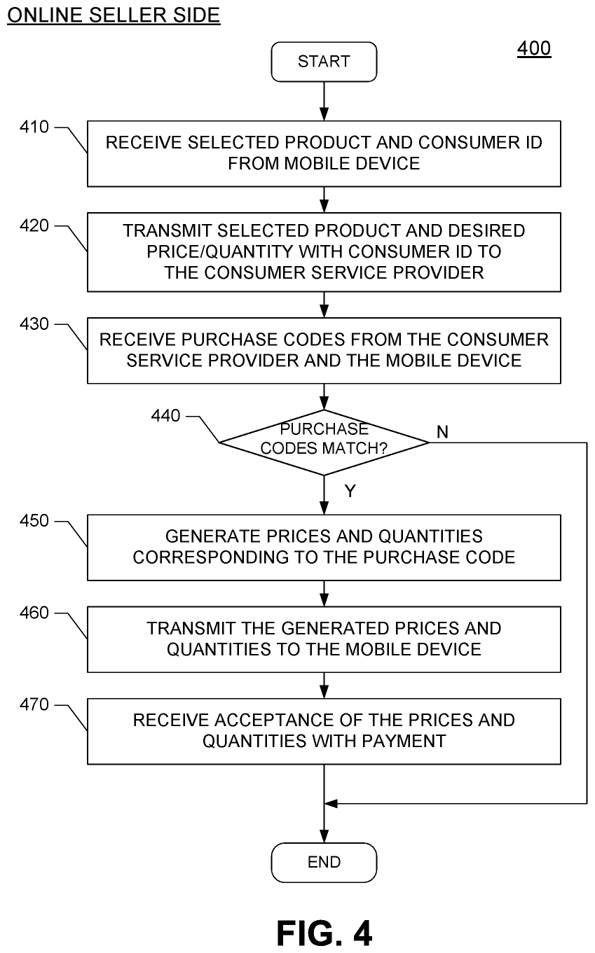

FIG. 4 is a flow diagram of an e-commerce method 400 from the online seller side in accordance with one implementation of the present disclosure. In the illustrated implementation of FIG. 4, the online seller 110 receives the identifier of the selected product, the desired price and quantity, and the consumer ID from the mobile device 120, at step 410, and transmits them to the consumer service provider 140, at step 420. In one implementation, the identifier of the selected product, the desired price and quantity, and the consumer ID are also sent directly to the consumer service provider 140 from the mobile device 120 so that the consumer service provider 140 can analyze the data to generate the purchase code when the data is received from both the consumer service provider 140 and the mobile device 120. Once the data is sent, the purchase code is received, at step 430, from the consumer service provider 140 and the mobile device 120.

In one implementation, once the purchase code is received from the consumer service provider 140 and the mobile device 120, the online seller 110 checks, at step 440, whether the received purchase code received from the consumer service provider 140 matches the purchase code received from the mobile device 120. Once the codes match, at step 440, the prices and the quantity for each price are generated, at step 450, corresponding to the purchase code, and transmitted, at step 460, to the mobile device 120. In one implementation, the prices and the quantity of each price are calculated based on table entries corresponding to the purchase code. For example, a table entry of the first column (e.g., $10) for the selected product is multiplied by a first decimal number (e.g., 0.5) of the purchase code to generate the price (i.e., $5) for the first quantity (which is taken from a table entry of the second column (e.g., 1)), while a table entry of the third column (e.g., $10) for the selected product is multiplied by a second decimal number (e.g., 0.7) of the purchase code to generate the price (i.e., $7) for the second quantity (which is taken from a table entry of the fourth column (e.g., 3)), and so on.

In the above example, the prices and the related parameters include at least three prices and the number of selected product for each of the at least three prices. In another example, the related parameters may include purchase periods coupled to the prices. For example, the first price is paid if the consumer buys the selected product within a 24-hour period, the second price is paid if the consumer buys the selected product after 24 hours but within one week, and so on. In yet another example, the related parameter may include purchase periods coupled to the quantities. For example, the first quantity tied to the first price is available only if the consumer buys the first quantity of the selected product within a 24-hour period, the second quantity tied to the second price is available only if the consumer buys the buys the second quantity of the selected product after 24 hours but within one week, and so on.

In one example, the selected product is a shampoo, wherein the first price is $5 and the corresponding quantity available at the first price is one, the second price is $7 and the corresponding quantity available at the second price is three, and the third price is $10 and the corresponding quantity available at the third price is unlimited.

Referring back to FIG. 2, once the purchase code is sent to the online seller 110, the mobile device 120 receives the prices and the related parameters (e.g., the quantity for each price) for the selected product, at step 260, fro the online seller 110. In the above example, the prices and the related parameters include at least three prices and the number of selected product for each of the at least three prices. However, in other implementations, there may only be one or two prices.

As stated above, the selected product is a shampoo, wherein the first price is $5 and the corresponding quantity available at the first price is one, the second price is $7 and the corresponding quantity available at the second price is three, and the third price is $10 and the corresponding quantity available at the third price is unlimited. Thus, if the consumer desires to buy 10 shampoos, the consumer will be offered one shampoo at $5, three shampoos for$7 each (for the total of $21), and six shampoos for $10 each (for the total of $60), for a grand total of $86.

Once the mobile device 120 receives the prices and the related parameters (e.g. the quantity for each price) for the selected product, at step 260, the mobile device 120 inquires the consumer, at step 270, whether the prices and the related parameters are acceptable. If the prices and the related parameters are acceptable, the mobile device 120 initiates the payment, at step 210, for the desired quantity of the selected product using the consumer card 130. Otherwise, the consumer uses the mobile device 120 to suggest a new desired price, at step 272, and returns the process 200 back to step 230 to start the consumer-tailored pricing all over again.

Referring back to FIG. 4, the online seller 110 receives the payment for the prices and the quantities, at step 470.

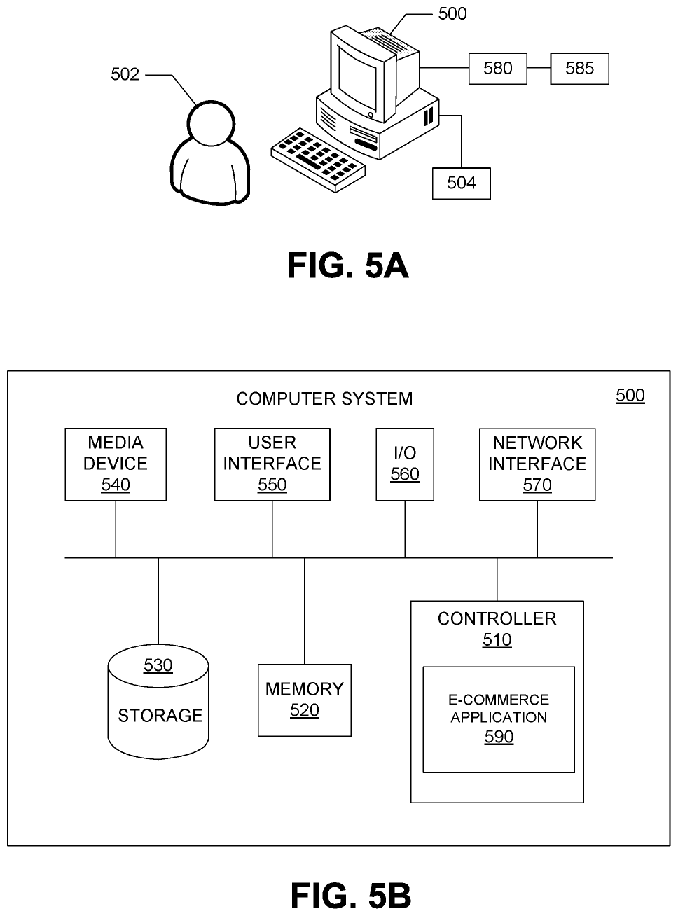

FIG. 5A is a representation of a computer system 500 and a user 502 in accordance with an implementation of the present disclosure. The user 502 uses the computer system 500 to implement an e-commerce application 590 as illustrated and described with respect to the system 100 of the block diagram shown in FIG. 1 and the methods 200, 300, 400 illustrated in FIGS. 2, 3, and 4.

The computer system 500 stores and executes the e-commerce application 590 of FIG. 5B. In addition, the computer system 500 may be in communication with a software program 504. Software program 504 may include the software code for the e-commerce application 590. Software program 504 may be loaded on an external medium such as a CD, DVD, or a storage drive, as will be explained further below.

Furthermore, computer system 500 may be connected to a network 580. The network 580 can be connected in various different architectures, for example, client-server architecture, a Peer-to-Peer network architecture, or other type of architectures. For example, network 580 can be in communication with a server 585 that coordinates engines and data used within the e-commerce application 590. Also, the network can be different types of networks. For example, the network 580 can be the Internet, a Local Area Network or any variations of Local Area Network, a Wide Area Network, a Metropolitan Area Network, an Intranet or Extranet, or a wireless network.

FIG. 5B is a functional block diagram illustrating the computer system 500 hosting the e-commerce application 590 in accordance with an implementation of the present disclosure. A controller 510 is a programmable processor and controls the operation of the computer system 500 and its components. The controller 510 loads instructions (e.g., in the form of a computer program) from the memory 520 or an embedded controller memory (not shown) and executes these instructions to control the system. In its execution, the controller 510 provides the e-commerce application 590 with a software system, such as to enable the creation and configuration of engines and data extractors within the e-commerce application 590. Alternatively, this service can be implemented as separate hardware components in the controller 510 or the computer system 500.

Memory 520 stores data temporarily for use by the other components of the computer system 500. In one implementation, memory 520 is implemented as RAM. In one implementation, memory 520 also includes long-term or permanent memory, such as flash memory and/or ROM.

Storage 530 stores data either temporarily or for long periods of time for use by the other components of the computer system 500. For example, storage 530 stores data used by the e-commerce application 590. In one implementation, storage 530 is a hard disk drive.

The media device 540 receives removable media and reads and/or writes data to the inserted media. In one implementation, for example, the media device 540 is an optical disc drive.

The user interface 550 includes components for accepting user input from the user of the computer system 500 and presenting information to the user 502. In one implementation, the user interface 550 includes a keyboard, a mouse, audio speakers, and a display. The controller 510 uses input from the user 502 to adjust the operation of the computer system 500.

The I/O interface 560 includes one or more I/O ports to connect to corresponding I/O devices, such as external storage or supplemental devices (e.g., a printer or a PDA). In one implementation, the ports of the I/O interface 560 include ports such as: USB ports, PCMCIA ports, serial ports, and/or parallel ports. In another implementation, the I/O interface 560 includes a wireless interface for communication with external devices wirelessly.

The network interface 570 includes a wired and/or wireless network connection, such as an RJ-45 or “Wi-Fi” interface (including, but not limited to 802.11) supporting an Ethernet connection.

The computer system 500 includes additional hardware and software typical of computer systems (e.g., power, cooling, operating system), though these components are not specifically shown in FIG. 5B for simplicity. In other implementations, different configurations of the computer system can be used (e.g., different bus or storage configurations or a multi-processor configuration).

In one implementation, the system 100 is a system configured entirely with hardware including one or more digital signal processors (DSPs), general purpose microprocessors, application specific integrated circuits (ASICs), field programmable gate/logic arrays (FPGAs), or other equivalent integrated or discrete logic circuitry. In another implementation, the system 100 is configured with a combination of hardware and software.

The description herein of the disclosed implementations is provided to enable any person skilled in the art to make or use the present disclosure. Numerous modifications to these implementations would be readily apparent to those skilled in the art, and the principals defined herein can be applied to other implementations without departing from the spirit or scope of the present disclosure. Thus, the present disclosure is not intended to be limited to the implementations shown herein but is to be accorded the widest scope consistent with the principal and novel features disclosed herein.

Various implementations of the present disclosure are realized in electronic hardware, computer software, or combinations of these technologies. Some implementations include one or more computer programs executed by one or more computing devices. In general, the computing device includes one or more processors, one or more data-storage components (e.g., volatile or non-volatile memory modules and persistent optical and magnetic storage devices, such as hard and floppy disk drives, CD-ROM drives, and magnetic tape drives), one or more input devices (e.g., game controllers, mice and keyboards), and one or more output devices (e.g., display devices).

The computer programs include executable code that is usually stored in a persistent storage medium and then copied into memory at run-time. At least one processor executes the code by retrieving program instructions from memory in a prescribed order. When executing the program code, the computer receives data from the input and/or storage devices, performs operations on the data, and then delivers the resulting data to the output and/or storage devices.

Those of skill in the art will appreciate that the various illustrative modules and method steps described herein can be implemented as electronic hardware, software, firmware or combinations of the foregoing. To clearly illustrate this interchangeability of hardware and software, various illustrative modules and method steps have been described herein generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the present disclosure. In addition, the grouping of functions within a module or step is for ease of description. Specific functions can be moved from one module or step to another without departing from the present disclosure.

All features of each above-discussed example are not necessarily required in a particular implementation of the present disclosure. Further, it is to be understood that the description and drawings presented herein are representative of the subject matter which is broadly contemplated by the present disclosure. It is further understood that the scope of the present disclosure fully encompasses other implementations that may become obvious to those skilled in the art and that the scope of the present disclosure is accordingly limited by nothing other than the appended claims.

1. A method for receiving a consumer-tailored pricing at a mobile device, the method comprising:
selecting a product having a product identifier from an online seller using the mobile device;
reading a consumer ID from a consumer card using the mobile device;
transmitting first data including the product identifier of the selected product, the consumer ID, and desired price and quantity of the selected product to a consumer service provider,
wherein the consumer service provider generates a purchase code based on the first data once the consumer ID is verified,
wherein the consumer ID is verified when the consumer service provider sends a verification code to the mobile device and receives back the verification code to verify that the consumer ID is associated with the mobile device which is registered with the consumer service provider along with the consumer ID;
receiving the purchase code from the consumer service provider and transmitting the purchase code to the online seller; and
receiving the consumer-tailored pricing for the selected product from the online seller.

2. The method of claim 1, wherein the custom-tailored pricing for the selected product is generated by the online seller and transmitted to the mobile device once purchase codes received from the consumer service provider and the mobile device match.

3. The method of claim 1, wherein the consumer service provider generates the purchase code when requests are received from both the online seller and the mobile device.

4. The method of claim 1, wherein the consumer ID is in a code form.

5. The method of claim 1, wherein the consumer service provider generates the purchase code using a purchase history of the consumer in addition to the first data received from the mobile device.

6. The method of claim 5, further comprising:
determining whether the consumer had purchased the selected product before from the online seller; and
retrieving and using a detailed purchase history of the selected product in addition to purchase history of the consumer when it is determined that the consumer had purchased the selected product before from the online seller.

7. The method of claim 5, further comprising
retrieving and using consumer ratings and online shopping habits of the consumer in addition to purchase history of the consumer.

8. The method of claim 1, wherein the consumer service provider generates the purchase code on a point system.

9. A system for receiving a consumer-tailored pricing by generating a purchase code after authenticating an association between a mobile device and a consumer card, the system comprising:
a consumer service provider;
a memory;
a downloadable software module that operates on the mobile device, the software module including instructions to browse, select, and transmit a product identifier of a product selected from an online seller, desired price and quantity of the selected product, and a consumer ID to the consumer service provider, and
a processor coupled to the memory programmed with executable instructions, including, a consumer interface including a reader for obtaining the consumer ID from the consumer card, wherein the consumer interface transmits the consumer ID to the mobile device;
wherein the consumer service provider generates and transmits a purchase code based on the first data once the consumer ID is verified, wherein the consumer ID is verified when the consumer service provider sends a verification code to the mobile device and receives back the verification code to verify that the consumer ID is associated with the mobile device which is registered with the consumer service provider along with the consumer ID; and
wherein the processor receives the purchase code from the consumer service provider and transmits the purchase code to the online seller, and receives the consumer-tailored pricing for the selected product from the online seller.

10. The system of claim 9, wherein the consumer card is issued by the consumer service provider.

11. The system of claim 9, wherein the consumer card is issued by a third party credit company not related to the consumer service provider.

12. The system of claim 9, wherein the reader is a code reader coupled to the mobile device.

13. The system of claim 9, wherein the consumer ID is one of bar code or QR code printed on the consumer card.

14. The system of claim 9, wherein the consumer ID is a code embedded in the consumer card which is read by the reader coupled to the mobile device.

15. The system of claim 9, wherein the consumer service provider is a credit service provider which evaluates the online credit ratings of consumers and provides online sellers with standards with which to determine the prices for products offered online by the online sellers.

16. A non-transitory computer-readable storage medium storing a computer program to receive a consumer-tailored pricing, the computer program comprising executable instructions that cause a computer to:
select a product having a product identifier from an online seller;
read a consumer ID from a consumer card;
transmit first data including the product identifier of the selected product, the consumer ID, and desired price and quantity of the selected product to a consumer service provider,
wherein the consumer service provider generates a purchase code based on the first data once the consumer ID is verified,
wherein the consumer ID is verified when the consumer service provider sends a verification code to the computer and receives back the verification code to verify that the consumer ID is associated with the computer which is registered with the consumer service provider along with the consumer ID;
receive the purchase code from the consumer service provider and transmit the purchase code to the online seller; and
receive the consumer-tailored pricing for the selected product from the online seller.

17. The non-transitory computer-readable Storage medium of claim 16, wherein the custom-tailored pricing for the selected product is generated by the online seller and transmitted to the computer once purchase codes received from the consumer service provider and the computer match.

18. The non-transitory computer-readable storage medium of claim 16, wherein the consumer service provider generates the purchase code when requests are received from both the online seller and the computer.

19. The non-transitory computer-readable storage medium of claim 16, wherein the consumer service provider generates the purchase code on a point system.

20. The non-transitory computer-readable storage medium of claim 16, wherein the consumer ID is in a code form.
